(19) United States
(12) Patent Application Publication
(10) Pub. No.: US 2023/0334345 A1
(43) Pub. Date: Oct. 19, 2023

(54) ABDUCTIVE REASONING APPARATUS, ABDUCTIVE REASONING METHOD, AND NON-TRANSITORY COMPUTER READABLE MEDIUM

(71) Applicant: NEC Corporation, Minato-ku, Tokyo (JP)

(72) Inventor: Kazeto Yamamoto, Tokyo (JP)

(73) Assignee: NEC Corporation, Minato-ku, Tokyo (JP)

(21) Appl. No.: 18/023,899

(22) PCT Filed: Sep. 3, 2020
(86) PCT No.: PCT/JP2020/033477

§ 371 Date: Feb. 28, 2023

(51) Int. Cl. G06N 5/04

(52) U.S. Cl. CPC G06N 5/041

(57) ABSTRACT

An abductive reasoning apparatus (1) includes a generation unit (11) configured to generate a candidate hypothesis from background knowledge and a query logical expression, the background knowledge being a set of given rules that if an antecedent holds, a consequent holds, and the query logical expression indicating observed information by using a logical expression, a constraint determination unit (12) configured to determine whether or not the generated candidate hypothesis contradicts a logical constraint to be satisfied by the generated candidate hypothesis and excluding the candidate hypothesis from a set of the generated candidate hypotheses when the candidate hypothesis contradicts the logical constraint, and a search unit (13) configured to search for a best hypothesis based on the set after the exclusion and then outputting the best hypothesis.

### TECHNICAL FIELD

The present disclosure relates to an abductive reasoning apparatus, an abductive reasoning method, and a non-transitory computer readable medium, and in particular, to an abductive reasoning apparatus, an abductive reasoning method, and a non-transitory computer readable medium for performing abductive reasoning.

### BACKGROUND ART

An abductive reasoning (abduction) is form of a reasoning in which a query logical expression (query) and background knowledge are received and then a best logical expression based on a predetermined evaluation function is output. Here, the predetermined evaluation function is a function (evaluation function) that shows the goodness of each candidate with a real value. Also, the best logical expression is the best logical expression (best hypothesis, solution hypothesis) among logical expressions (hypotheses) that are consistent with the background knowledge and can be deductively derived from query logical expressions.

Non-Patent Literature 1 discloses a method for implementing abductive reasoning on a computer. Patent Literature 1 also discloses techniques related to an abductive reasoning apparatus that performs abductive reasoning based on observed event data and knowledge data. Patent Literature 2 discloses a technique related to an inference system for design and planning-type problem areas.

### CITATION LIST

### Patent Literature

Patent Literature 1: International Patent Publication No. WO2020/008632
Patent Literature 2: Japanese Unexamined Patent Application Publication No. H05-282148

### Non Patent Literature

Non-Patent Literature 1: Naoya Inoue and Kentaro Inui. ILP-based Reasoning for Weighted Abduction. In Proceedings of AAAI Workshop on Plan, Activity and Intent Recognition, pp. 25-32, August 2011.

### SUMMARY OF INVENTION

### Technical Problem

In the technique of Non-Patent Literature 1, even inappropriate candidate hypotheses that contradict some constraints are always included in a search space of a solution hypothesis (best hypothesis). Therefore, there has been a problem that the calculation speed for solving an optimization problem is significantly reduced in a situation where many such inappropriate candidate hypotheses are included in the search space. Note that in Patent Literature 1, redundant observed event data is removed but inappropriate candidate hypotheses that contradict the constraints may be included therein. Furthermore, Patent Literature 2 does not use the evaluation function described above.

The present disclosure has been made to solve such a problem and an object thereof is to provide an abductive reasoning apparatus, an abductive reasoning method, and a non-transitory computer readable medium for improving overall calculation efficiency of reasoning in an abductive reasoning scheme.

### Solution to Problem

In a first example aspect of the present disclosure, an abductive reasoning apparatus includes:
generation means for generating a candidate hypothesis from background knowledge and a query logical expression, the background knowledge being a set of given rules that if an antecedent holds, a consequent holds, and the query logical expression indicating observed information by using a logical expression;
constraint determination means for determining whether or not the generated candidate hypothesis contradicts a logical constraint to be satisfied by the generated candidate hypothesis and excluding the candidate hypothesis from a set of the generated candidate hypotheses when the candidate hypothesis contradicts the logical constraints; and
search means for searching for a best hypothesis based on the set after the exclusion and then outputting the best hypothesis.

In a second example aspect of the present disclosure, an abductive reasoning method performed by a computer includes:
generating a candidate hypothesis from background knowledge and a query logical expression, the background knowledge being a set of given rules that if an antecedent holds, a consequent holds, and the query logical expression indicating observed information by using a logical expression;
determining whether or not the generated candidate hypothesis contradicts a logical constraint to be satisfied by the generated candidate hypothesis;
excluding the candidate hypothesis from a set of the generated candidate hypotheses when the candidate hypothesis contradicts the logical constraints; and
searching for a best hypothesis based on the set after the exclusion and then outputting the best hypothesis.

In a third example aspect of the present disclosure, a non-transitory computer readable medium storing an abductive reasoning program for causing a computer to execute:
processing of generating a candidate hypothesis from background knowledge and a query logical expression, the background knowledge being a set of given rules that if an antecedent holds, a consequent holds, and the query logical expression indicating observed information by using a logical expression;
processing of determining whether or not the generated candidate hypothesis contradicts a logical constraint to be satisfied by the generated candidate hypothesis;
excluding the candidate hypothesis from a set of the generated candidate hypotheses when the candidate hypothesis contradicts the logical constraints; and
processing of searching for a best hypothesis based on the set after the exclusion and then outputting the best hypothesis.

### Advantageous Effects of Invention

According to the present disclosure, it is possible to provide an abductive reasoning apparatus, an abductive reasoning method, and a non-transitory computer readable medium for improving overall calculation efficiency of reasoning in an abductive reasoning scheme.

### BRIEF DESCRIPTION OF DRAWINGS

FIG. 1 is a block diagram showing a configuration of an abductive reasoning apparatus according to a first example embodiment;

FIG. 2 is a flowchart showing a flow of a abductive reasoning method according to the first example embodiment;

FIG. 3 shows an example of background knowledge;

FIG. 4 shows an example of a query logical expression;

FIG. 5 shows an example of a latent hypothesis graph when a related technique is applied;

FIG. 6 is a block diagram showing a configuration of an abductive reasoning apparatus according to a second example embodiment;

FIG. 7 is a flowchart showing a flow of a abductive reasoning method according to the second example embodiment;

FIG. 8 shows an example of a latent hypothesis graph after a backward chaining operation according to the second example embodiment;

FIG. 9 shows an example of a latent hypothesis graph after a unification operation according to the second example embodiment;

FIG. 10 is a block diagram showing a hardware configuration of the abductive reasoning apparatus according to the second example embodiment; and

FIG. 11 is a flowchart showing a flow of a abductive reasoning method according to a third example embodiment.

### EXAMPLE EMBODIMENT

Here, an outline of background techniques and problem to be solved are described to better understand the example embodiments of the disclosure.

In the scheme according to Non-Patent Literature 1, candidates for a best hypothesis (candidate hypotheses) are first listed from query logical expressions and background knowledge. In this scheme, the problem of searching for the best hypothesis among the listed candidate hypotheses is then transformed into an equivalent as a constrained combinatorial optimization problem such as an integer linear programming problem. An external solver is then used to obtain the best hypothesis for the transformed optimization problem. More specifically, in the scheme, a set of candidate hypotheses listed from the query logical expressions and the background knowledge is expressed as a directed graph (Latent Hypotheses Graph) of a derived relation between respective logical expressions with respect to a union of a set of the logical expressions constituting each of the set of candidate hypotheses. In the latent hypothesis graph, the logical expressions included in each candidate hypothesis are expressed as nodes on the graph, and the derived relation between the logical expressions are expressed as edges. In the present specification, the query logical expressions are shown as nodes surrounded by dotted lines. At this time, each candidate hypothesis corresponds to one of subgraphs of the latent hypothesis graph. The problem of searching for a solution hypothesis then comes down to a problem of searching for the best subgraph in the latent hypothesis graph. Also, the logical constraints that each candidate hypothesis should satisfy to conform its consistency with the background knowledge are expressed as constraints in the constrained combinatorial optimization problem.

However, in Non-Patent Literature 1, even inappropriate candidate hypotheses that contradict some constraints are always included in the search space of the solution hypothesis (best hypothesis). Therefore, there has been a problem that the calculation speed for solving an optimization problem is significantly reduced in a situation where many such inappropriate candidate hypotheses are included.

In Non-Patent Literature 1, as described above, the logical constraints to be satisfied by each candidate hypothesis are expressed as constraints in the constrained combinatorial optimization problem to thereby exclude inappropriate hypotheses from the candidates. That is, a problem in Non-Patent Literature 1 is that it cannot be determined whether each candidate hypothesis contradicts the logical constraints until it is given to the external solver. Therefore, even if there are inappropriate hypothesis candidates that always contradict some logical constraint, they cannot be detected until they are given to the external solver. Thus, the more inappropriate hypothesis candidates there are, the more redundant the latent hypothesis graph and the constrained combinatorial optimization problem become, each including a candidate hypothesis that cannot be solved, thereby resulting in longer calculation time for reasoning.

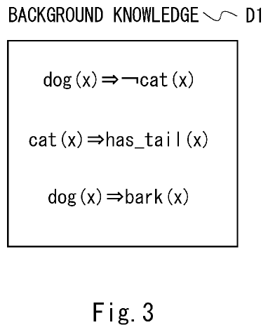

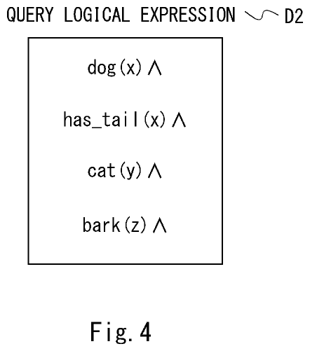

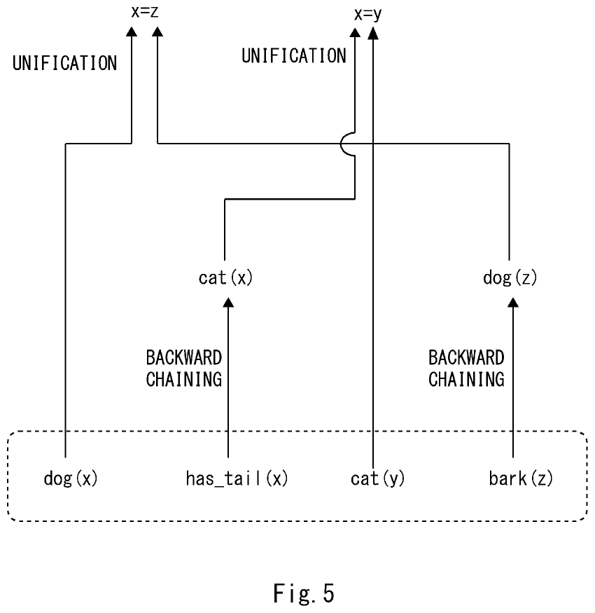

For example, FIG. 3 shows an example of background knowledge D1. FIG. 4 shows an example of a query logical expression D2. FIG. 5 shows an example of a latent hypothesis graph when the scheme according to Non-Patent Literature 1 (related technique) is applied to the background knowledge D1 and the query logical expression D2. When the candidate hypothesis set is extended in accordance with the scheme of Non-Patent Literature 1, a literal cat(x) is first added to the latent hypothesis graph by applying backwardly a second rule cat(x)→has_tail(x) of the background knowledge D1 to a literal has_tail(x) shown at the bottom of FIG. 5. An equivalence relation between the variables (x=y) is then added to the latent hypothesis graph by a unification operation that regards cat(x) and cat(y) as identical logical expressions.

In this case, since dog(x) and cat(x) contradict a first rule dog(x)→¬cat(x) in the background knowledge D1, they cannot hold at the same time. Also, dog(x) is included in the query logical expressions and always holds in this reasoning. As a result, a hypothesis including cat(x) cannot hold as a solution hypothesis. Thus, ideally, this cat(x) may be excluded from the latent hypothesis graph. If candidate hypotheses that contradict the logical constraints can be excluded from the candidate hypothesis set, the calculation time of the whole abductive reasoning processing can be expected to be reduced by that amount of calculation required for the candidate hypotheses. However, in Non-Patent Literature 1, logical constraints between such literals can only be considered as constraints in the combinatorial optimization problem. Therefore, the hypothesis shown in FIG. 5 is listed as a candidate hypothesis and expressed in the combinatorial optimization problem, even though it cannot hold as a solution hypothesis.

Example embodiments of the present disclosure aim to solve such a problem and improve the overall calculation efficiency of reasoning in the abductive reasoning method.

Example embodiments of the present disclosure are described in detail below with reference to the drawings. In each drawing, the same or corresponding elements are given the same signs, and repeated descriptions are omitted as necessary for clarity.

### First Example Embodiment

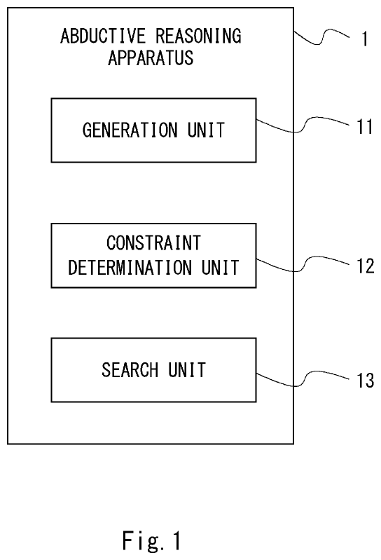

FIG. 1 is a block diagram showing a configuration of an abductive reasoning apparatus 1 according to a first example embodiment. An abductive reasoning apparatus 1 includes a generation unit 11, a constraint determination unit 12, and a search unit 13. The generation unit 11 generates candidate hypotheses from background knowledge and query logical expressions. Here, the background knowledge is a given set of rules that if an antecedent holds, a consequent holds. The query logical expression is a logical expression indicating observed information.

The constraint determination unit 12 determines whether or not the generated candidate hypothesis contradicts the logical constraints to be satisfied, and if it does, excludes the candidate hypothesis from the set of generated candidate hypotheses. The search unit 13 then searches for a best hypothesis based on the set after the exclusion and then outputs the best hypothesis.

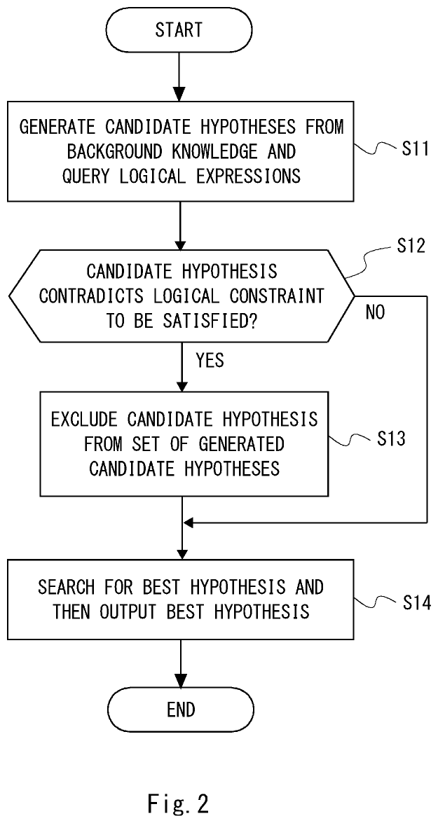

FIG. 2 is flowchart showing a flow of a abductive reasoning method according to the first example embodiment. The generation unit 11 generates candidate hypotheses from the background knowledge and the query logical expressions (S11). Next, the constraint determination unit 12 determines whether or not the generated candidate hypothesis contradicts the logical constraint to be satisfied (S12). If the candidate hypothesis contradicts the logical constraint, the constraint determination unit 12 excludes the candidate hypothesis from the set of the generated candidate hypotheses (S13). Next, the processing proceeds to Step S14. Alternatively, if the candidate hypothesis does not contradict the logical constraints in Step S12, the processing proceeds to Step S14 as well. After that, the search unit 13 searches for the best hypothesis based on the set after the exclusion and then outputs the best hypothesis (S14).

As described so far, in this example embodiment, before the best hypothesis is searched, a candidate hypothesis that contradicts the logical constraints is excluded from the candidate hypothesis set to be searched. Therefore, search processing can be performed with a smaller search space than that in Non-Patent Literature 1. This improves the overall calculation efficiency of the reasoning in the abductive reasoning method.

The abductive reasoning apparatus 1 includes a processor, a memory, and a storage apparatus as a configuration not shown. The storage apparatus stores a computer program in which processing of the abductive reasoning method according to this example embodiment is implemented. The processor then reads the computer program from the storage apparatus into the memory and executes the computer program. Thus, the processor implements the functions of the generation unit 11, the constraint determination unit 12, and the search unit 13.

Alternatively, the generation unit 11, the constraint determination unit 12, and the search unit 13 may be implemented by dedicated hardware. Further, some or all of the constituent elements of each apparatus may be implemented by general-purpose or dedicated circuitry, processors, etc., or a combination thereof. These constituent elements may be composed of a single chip or a plurality of chips connected via a bus. Some or all of the constituent elements of each apparatus may be implemented by a combination of the circuitry, the program, and the like described above. The processor may be a CPU (Central Processing Unit), a GPU (Graphics Processing Unit), an FPGA (field-programmable gate array), quantum processor (quantum computer control chip), or the like.

Further, when some or all of the constituent elements of the abductive reasoning apparatus 1 are implemented by a plurality of information processing apparatuses, circuitry, etc., the plurality of information processing apparatuses, circuitry, and the like, may be collectively arranged or arranged separate from each other.

For example, the information processing apparatus, the circuitry, and the like may be implemented as a form where they are connected to each other via a communication network, such as a client server system, a cloud computing system, and the like.

Further, the function of the abductive reasoning apparatus 1 may be provided in a SaaS (Software as a Service) format.

### Second Example Embodiment

A second example embodiment is a specific example of the first example embodiment described above. Here, in the processing of listing candidate hypotheses from the query logical expressions and the background knowledge, logical constraints to be considered in each candidate hypothesis are listed and verified, and at the same time inappropriate candidate hypotheses that always lead to contradiction are excluded from the search space at the time of the listing, thereby improving the overall calculation efficiency of reasoning.

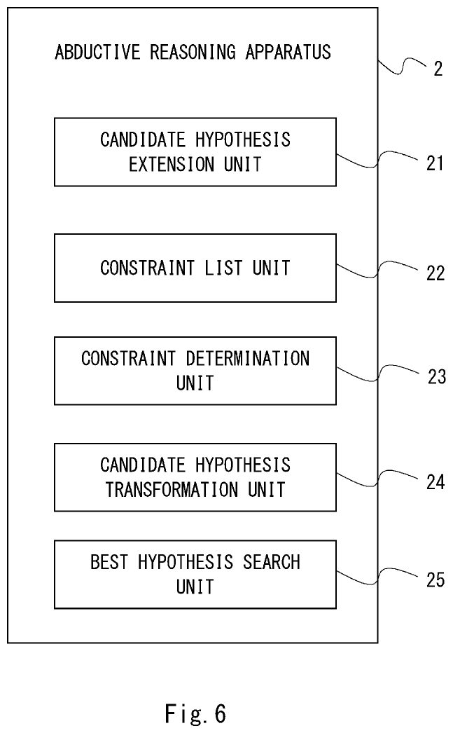

FIG. 6 is a block diagram showing a configuration of an abductive reasoning apparatus 2 according to the second example embodiment. The abductive reasoning apparatus 2 is an information processing apparatus that receives the background knowledge and query logical expressions as inputs, generates a candidate hypothesis set as described later, transforms the candidate hypothesis set into an optimization problem, searches for the best hypothesis, and then outputs it. The abductive reasoning apparatus 2 may be redundant using a plurality of computers, and each functional block may be implemented by the plurality of computers.

The abductive reasoning apparatus 2 includes a candidate hypothesis extension unit 21, a constraint list unit 22, a constraint determination unit 23, a candidate hypothesis transformation unit 24, and a best hypothesis search unit 25. The candidate hypothesis extension unit 21 is an example of the generation unit 11 described above. The constraint list unit 22 and the constraint determination unit 23 are examples of the constraint determination unit 12 described above. The candidate hypothesis transformation unit 24 and the best hypothesis search unit 25 are examples of the search unit 13 described above.

The candidate hypothesis extension unit 21 receives the background knowledge D1 and the query logical expression D2 as inputs and then outputs the candidate hypothesis set D3. Here, the candidate hypothesis extension unit 21 may accept the background knowledge D1 and the query logical expression D2 as external inputs or may read the background knowledge D1 and the query logical expression D2 stored in a built-in storage apparatus (not shown) as inputs.

The background knowledge D1 is a set of inference rules. The inference rules are generally expressed by horn clauses in first-order predicate logic. The background knowledge D1 is, for example, the one shown in the FIG. 3 described above. The query logical expression D2 is a concatenation of first-order predicate logical literals. The first-order predicate logic literals are atomic logical expressions in a first-order predicate logic, or their negations.

More specifically, the candidate hypothesis extension unit 21 sets a latent hypothesis graph corresponding to the candidate hypothesis consisting only of the query logical expression D2 as an initial state of the candidate hypothesis set. Next, the candidate hypothesis extension unit 21 repeats the operation of extending the latent hypothesis graph, i.e., the operation of sequentially generating a new candidate hypothesis, until no new operation can be performed. In this manner, the candidate hypothesis extension unit 21 extends the candidate hypothesis set D3. Note that basically, the operation used in Non-Patent Literature 1 may be employed, but other methods may be used.

The candidate hypothesis set D3 is a set of candidate hypotheses output by the abductive reasoning apparatus 2, which is basically expressed in the form of a latent hypothesis graph. Each candidate hypothesis is expressed as a concatenation of first-order predicate logic literals, and a latent hypothesis graph is expressed as a directed graph with the first-order predicate logic literals of each candidate hypothesis as nodes. In other words, the candidate hypothesis extension unit 21 constructs the candidate hypothesis set D3 by extending the directed graph corresponding to the candidate hypothesis set D3. The candidate hypothesis set D3 may be stored in a memory (described later) built in the abductive reasoning apparatus 2.

For the unprocessed candidate hypothesis in the candidate hypothesis set D3, the constraint list unit 22 lists the logical constraints to be satisfied by the hypothesis and adds them to the constraint set D4. The constraint set D4 is a set of logical constraints to be satisfied by each candidate hypothesis, which is output by the constraint list unit 22. Each constraint is generally expressed as a concatenation of first-order predicate logic literals. In particular, the constraint list unit 22 lists the logical constraints that should be satisfied by the generated candidate hypothesis each time the candidate hypothesis extension unit 21 generates one candidate hypothesis. In addition, it can be said that the constraint list unit 22 lists the logical constraints to be satisfied by the extended part of the directed graph. The constraint set D4 may be stored in a memory built in the abductive reasoning apparatus 2.

With regard to the candidate hypothesis newly generated by the candidate hypothesis extension unit 21 and the logical constraints listed by the constraint list unit 22, the constraint determination unit 23 determines whether or not there is a logical constraint that cannot be satisfied by the candidate hypothesis. If a logical constraint that cannot be satisfied by the candidate hypothesis is found, the constraint determination unit 23 excludes the candidate hypothesis from the candidate hypothesis set D3. In particular, each time the candidate hypothesis extension unit 21 generates one candidate hypothesis, the constraint determination unit 23 according to this example embodiment determines whether or not the candidate hypothesis contradicts the logical constraints, and if it does, excludes the candidate hypothesis from the candidate hypothesis set D3. More specifically, each time a logical constraint is listed, the constraint determination unit 23 determines whether or not the candidate hypothesis contradicts the logical constraint, and if it does, excludes the candidate hypothesis from the set. Therefore, it can be said that the candidate hypothesis extension unit 21 extends the candidate hypothesis set by attempting to generate the next candidate hypothesis after the exclusion by the constraint determination unit 23.

The candidate hypothesis transformation unit 24 receives the candidate hypothesis set D3 and the constraint set D4 as inputs and then outputs a constrained combinatorial optimization problem equivalent to a procedure for selecting the best candidate hypothesis satisfying all logical constraints from the candidate hypothesis set D3. Basically, the transformation method used in Non-Patent Literature 1 can be used, but other methods can also be used.

The best hypothesis search unit 25 receives as input the constrained combinatorial optimization problem generated by the candidate hypothesis transformation unit 24, searches for the optimal solution to the constrained combinatorial optimization problem by using the external solver, and then outputs the best hypothesis D5 obtained from the optimal solution. The external solver can use a known technique that receives the optimization problem as an input and then outputs the optimal solution. The best hypothesis D5 satisfies the logical constraints to be satisfied and is the best one based on the evaluation function among the candidate hypotheses included in the candidate hypothesis set D3.

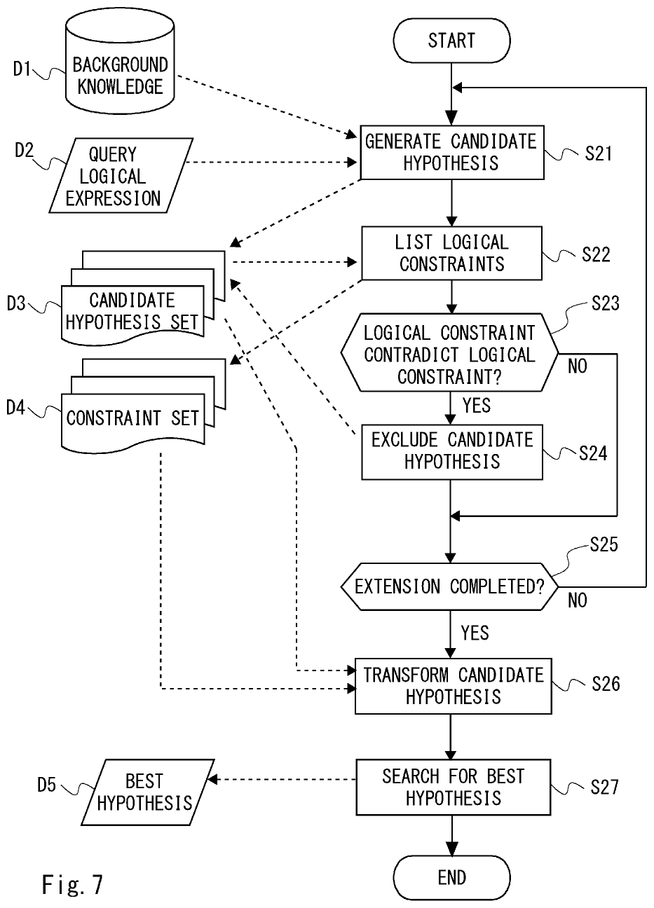

FIG. 7 is flowchart showing a flow of the abductive reasoning method according to the second example embodiment. First, the candidate hypothesis extension unit 21 receives the background knowledge D1 and the query logical expression D2 as an input, generates one candidate hypothesis to which one operation is applied, and then outputs it as the candidate hypothesis set D3 (S21).

For example, the candidate hypothesis extension unit 21 generates a new candidate hypothesis by selecting one applicable “operation” and then applying it to the candidate hypothesis consisting only of the query logical expression D2, which is the initial state of the candidate hypothesis set. Two operations are applicable here: backward chaining and unification. The backward chaining is an operation to apply the rules included in the background knowledge backwardly to an existing candidate hypothesis. When the candidate hypothesis extension unit 21 applies the backward chaining, it makes a consequent (right side, consequence) of one rule in the background knowledge D1 correspond to a literal in the candidate hypothesis, and then adds the literal corresponding to an antecedent (left side, assumption) of the rule to generate a new candidate hypothesis. The unification is an operation of generating a new candidate hypothesis for a literal pair with the same predicate in an existing candidate hypothesis by adding an equivalence relation between arguments so that they are identical. When the candidate hypothesis extension unit 21 applies the unification, it selects two literals among a plurality of literals of the generated candidate hypothesis, and then generates a candidate hypothesis in which the arguments of the selected literals are in an equivalence relation.

Next, the constraint list unit 22 lists the logical constraints to be satisfied by the candidate hypothesis generated in Step S21 (S22). More specifically, for each literal included in the candidate hypothesis and each rule included in the background knowledge D1, the constraint list unit 22 searches for a combination of literals that contradict the rule. Next, the constraint list unit 22 defines the state of not satisfying the combination as a logical constraint to be satisfied by each candidate hypothesis. That is, the constraint list unit 22 outputs the defined logical constraints to a memory or the like as the constraint set D4. Here, the “logical constraints to be satisfied” correspond to the negation of “combinations of literals that contradict the rule”.

Next, the constraint determination unit 23 determines whether or not the candidate hypothesis generated in Step S21 contradicts the logical constraints listed in Step S22 (S23). In other words, for each candidate hypothesis, the constraint determination unit 23 determines whether or not there are any unsatisfiable constraints that do not contradict each rule. Alternatively, the constraint determination unit 23 determines whether or not there is a rule that contradicts each candidate hypothesis. When it is determined that the logical constraint contradicts the candidate hypothesis, the constraint determination unit 23 excludes the candidate hypothesis from the candidate hypothesis set D3 (S24). If it is determined that the logical constraint does not contradict the logical constraint after Step S24 or in Step S23, the candidate hypothesis extension unit 21 determines whether or not the extension of the candidate hypothesis set D3 has been completed (S25). That is, the candidate hypothesis extension unit 21 determines whether or not the extension of the candidate hypothesis set D3 has converged. When it is determined that the extension has not completed (converged), the processing returns to Step S21.

When it is determined in Step S25 that the extension of the candidate hypothesis set D3 has been completed (converged), the candidate hypothesis transformation unit 24 transforms the candidate hypothesis set D3 and the constraint set D4 into the corresponding constrained combinatorial optimization problem (S26) and then outputs the converted constrained combinatorial optimization problem to the best hypothesis search unit 25. For example, assume that the output constrained combinatorial optimization problem is expressed as an integer linear programming problem. Here, the variables in the combinatorial optimization problem correspond to the presence or absence of literals in the candidate hypothesis. The constraints in the optimization problem are then used to express the logical constraints in the candidate hypothesis, the preconditions caused by the evaluation function, or the like. Furthermore, an objective function in the optimization problem is designed to be equivalent to the evaluation function in the abductive reasoning.

After that, the best hypothesis search unit 25 searches the candidate hypothesis set D3 for the best hypothesis D5 and then outputs the best hypothesis D5 (S27). This processing is achieved by using an external solver according to the type of the optimization problem output by the candidate hypothesis transformation unit 24. For example, the best hypothesis search unit 25 obtains an optimal solution by using a solver of the integer linear programming problem and then outputs the candidate hypothesis corresponding to the optimal solution as the best hypothesis.

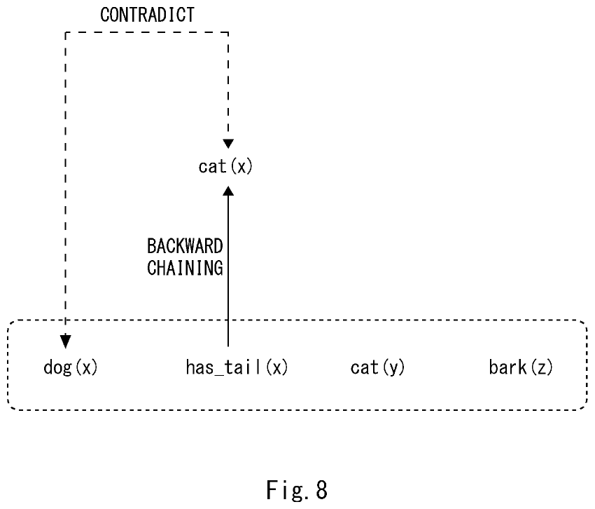

Next, a specific example will be described. Here, it is assumed that the candidate hypothesis set D3 in FIG. 3 and the query logical expression D2 in FIG. 4 described above are input to the abductive reasoning apparatus 2. At this time, the candidate hypothesis extension unit 21 generates a candidate hypothesis set from the background knowledge D1 and the query logical expression D2. Specifically, first, the candidate hypothesis extension unit 21 sets the candidate hypothesis {dox(x)∧has_tail(x)∧cat(y)∧bark(z)} consisting of only the query logical expression D2 as the initial state of the latent hypothesis graph corresponding to the candidate hypothesis set D3. Here, the candidate hypothesis extension unit 21 applies the backward chaining operation among the above-described two operations. Specifically, the candidate hypothesis extension unit 21 applies the backward chaining operation to the literal has_tail(x) by using the rule: ∀x cat(x)→has_tail(x). Thus, the candidate hypothesis extension unit 21 adds the literal cat(x) to the latent hypothesis graph. A result is shown, for example, in FIG. 8. FIG. 8 shows an example of the latent hypothesis graph after the backward chaining operation according to the second example embodiment. This is equivalent to the addition of the candidate hypothesis {dox(x)∧has_tail(x)∧cat(y)∧bark(z)∧cat(x)} to the candidate hypothesis set D3.

Next, the constraint list unit 22 lists the constraints to be satisfied between the literal cat(x) newly added to the latent hypothesis graph and the existing literal. This is equivalent to listing the constraints to be satisfied for the candidate hypotheses {dox(x)∧has_tail(x)∧cat(y)∧bark(z)∧cat(x)}. In this example, the following rule: ∀x dog(x)→¬cat(x) leads to a contradiction if dog(x)∧cat(x) in the candidate hypothesis holds. Therefore, the constraint to be satisfied is “dog(x)∧cat(x) must not hold”, that is, “not dog(x)∨not cat(x)” is obtained as a logical expression. Here, the term “not” indicates negation as failure.

Next, in a situation where the literal cat(x) newly added to the latent hypothesis graph holds, the constraint determination unit 23 determines whether or not there are any unsatisfiable constraints among logical constraints listed by the constraint list unit 22. In this example, dog(x) is a query logical expression and always holds, so if cat(x) holds, the above constraint “dog(x)∧cat(x) must not hold” is always violated. Therefore, since it is found that the candidate hypothesis including cat(x) could not be a solution hypothesis, the constraint determination unit 23 removes cat(x) from the latent hypothesis graph. This is equivalent to excluding candidate hypotheses including cat(x) from the candidate hypothesis set. In this example, the removal of cat(x) also means that the subsequent unification operations on cat(x) and cat(y) are no longer performed in Non-Patent Literature 1.

After that, the above procedure is repeated until there are no more applicable operations. In this example, the candidate hypothesis extension unit 21 applies backward chaining to the literal bark(z) by using the rule ∀x dog(x)→bark(x). Thus, the candidate hypothesis extension unit 21 adds the literal dog(z) to the latent hypothesis graph. It is then determined in Step S23 that the logical constraints listed in Step S22 are consistent.

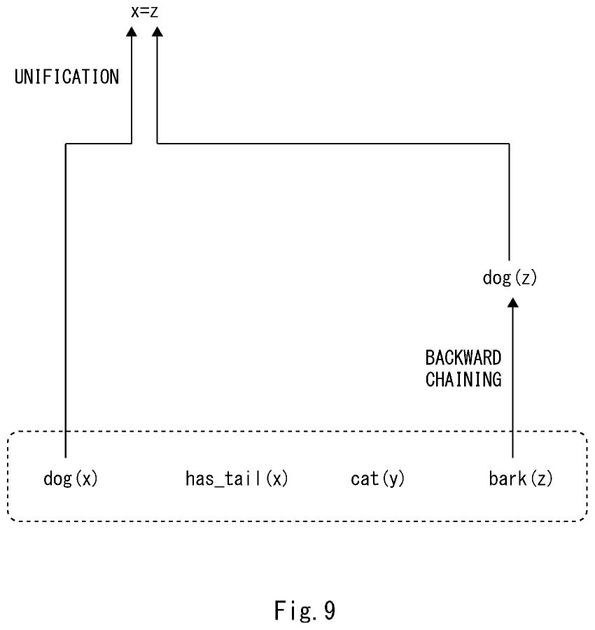

After that, the candidate hypothesis extension unit 21 performs a unification operation on the literals dog(x) and dog(z). Thus, the candidate hypothesis extension unit 21 adds the equivalence relation x=z to the latent hypothesis graph. Finally, the latent hypothesis graph, as shown in FIG. 9, is output as the candidate hypothesis set D3. FIG. 9 shows an example of the latent hypothesis graph after the unification operation according to the second example embodiment.

After that, the extension of the latent hypothesis graph is completed, and the candidate hypothesis transformation unit 24 expresses a procedure to search for the best hypothesis among the candidate hypotheses included in the candidate hypothesis set D3 and not satisfying the combination included in the set of latent contradiction as a constrained combinatorial optimization problem and then outputs it. For example, a procedure to search for the best hypothesis is expressed as an equivalent integer linear programming problem.

Next, the best hypothesis search unit 25 receives the constrained combinatorial optimization problem from the candidate hypothesis transformation unit 24 as an input, searches for the best hypothesis and then outputs it. For example, the best hypothesis search unit 25 receives the integer linear programming problem as an input and performs a search for the best hypothesis by solving it by using an external integer linear programming problem solver.

As described so far, in this example embodiment, by excluding redundant candidate hypotheses that cannot be a solution from a solution space at the time of listing, reasoning equivalent to that of Non-Patent Literature 1 or the like can be implemented more efficiently than in Non-Patent Literature 1 or the like in terms of memory usage efficiency and calculation efficiency. Therefore, this example embodiment is expected to be more useful than Non-Patent Literature 1 and the like in practical use.

In addition, the effect of this example embodiment has the following aspects.

A first effect is that inappropriate candidate hypotheses that always contradict constraints can be excluded from transformation into combinatorial optimization problems. The reason is that it is possible to verify whether or not an individual candidate hypothesis satisfies the constraints to be satisfied at the time when the candidate hypothesis is listed. If the candidate hypothesis is always found to contradict any of the constraints in the verification, the candidate hypothesis can be excluded from the candidate solutions.

A second effect is that the same reasoning as that of Non-Patent Literature 1 or the like can be expressed as a constrained combinatorial optimization problem smaller than that of Non-Patent Literature 1 or the like. The reason for this is that, since candidate hypotheses that always contradict some constraint can be excluded from the transformation into the combinatorial optimization problem by the first effect, the number of variables and constraints constituting the constrained combinatorial problem can be reduced by excluded number of candidate hypotheses.

A third effect is that the procedure to list candidate hypotheses can be performed more efficiently than in Non-Patent Literature 1 or the like in terms of both memory and calculation time. The reason for this is that, since the procedure to list the candidate hypotheses in Non-Patent Literature 1 or the like is implemented by repeating the operation of generating a new candidate hypothesis based on an already listed candidate hypothesis, by being able to exclude an inappropriate candidate hypothesis from the search space at the time when the inappropriate candidate hypothesis is listed by the first effect, all candidate hypothesis groups that should have been generated based on the candidate hypothesis can be avoided.

A fourth effect is that the entire procedure of abductive reasoning can be performed more efficiently than in conventional methods in terms of both memory and calculation time. This is because the third effect reduces the memory and calculation time required to list candidate hypotheses, and the second effect reduces the size of the constrained combinatorial optimization problem given to the solver. Therefore, this is because the memory and calculation time in the procedure to search for the optimal solution by the external solver is reduced.

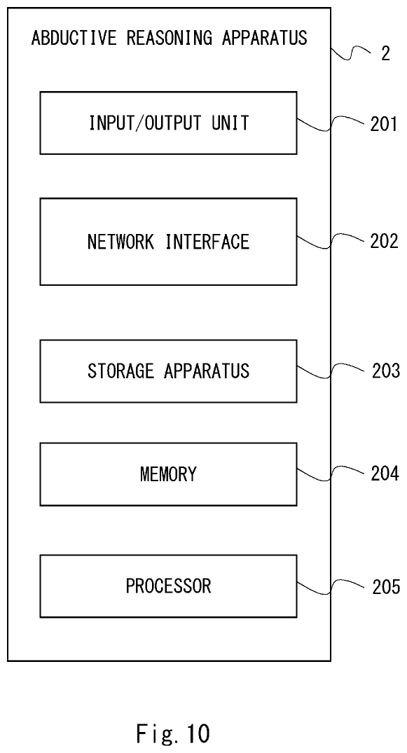

FIG. 10 is a block diagram showing a hardware configuration of the abductive reasoning apparatus 2 according to the second example embodiment. The abductive reasoning apparatus 2 includes an input/output unit 201, a network interface 202, a storage apparatus 203, a memory 204, and a processor 205. The input/output unit 201, the network interface 202, the storage apparatus 203, the memory 204, and the processor 205 are connected to each other via a data bus or the like.

The input/output unit 201 performs input/output between the abductive reasoning apparatus 2 and the outside. The network interface 202 is used to communicate with any other apparatus. The network interface 202 may include, for example, a network interface card (NIC).

The storage apparatus 203 is a non-volatile storage apparatus such as a hard disk or flash memory. The storage apparatus 203 may, for example, store some or all of the aforementioned background knowledge D1, query logical expression D2, candidate hypothesis set D3, constraint set D4, and best hypothesis D5. The storage apparatus 203 also stores a computer program in which processing of the abductive reasoning method according to this example embodiment is implemented. The computer program is software that includes one or more instructions.

The memory 204 is a volatile storage apparatus such as RAM (Random Access Memory). The memory 204 is a storage area for temporarily holding information during an operation of the processor 205. Therefore, the memory 204 may store some or all of the aforementioned background knowledge D1, query logical expression D2, candidate hypothesis set D3, constraint set D4, and best hypothesis D5. The memory 204 also stores the computer program read from the storage apparatus 203 by the processor 205.

The processor 205 is a control apparatus for controlling each component of the abductive reasoning apparatus 2. The processor 205 reads the computer program from the storage apparatus 203 into the memory 204 and executes the program. By doing so, the processor 205 implements the functions of the candidate hypothesis extension unit 21, the constraint list unit 22, the constraint determination unit 23, the candidate hypothesis transformation unit 24, and the best hypothesis search unit 25 described above.

### Third Example Embodiment

A third example embodiment is a modified example of the aforementioned second example embodiment. Here, once the candidate hypothesis set D3 is extended and the constraint set D4 is listed, and before the candidate hypothesis set D3 is transformed into an optimization problem, candidate hypotheses that contradict the logical constraints are excluded from the candidate hypothesis set D3. Since the configuration of the abductive reasoning apparatus 2 according to the third example embodiment is equivalent to that in FIG. 6, it is not shown in the drawing.

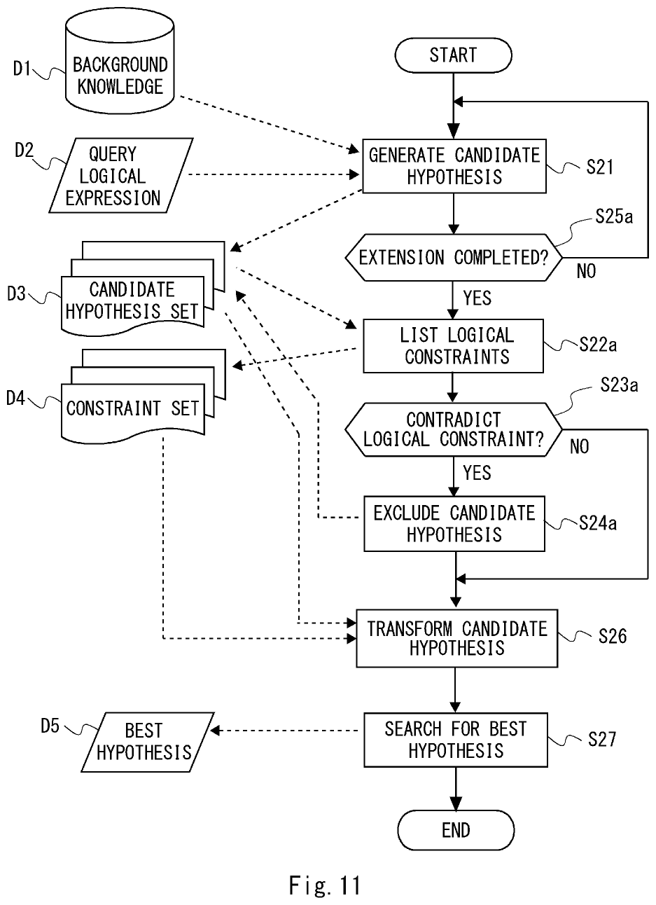

FIG. 11 is flowchart showing a flow of a abductive reasoning method according to the third example embodiment. First, the candidate hypothesis extension unit 21 inputs the background knowledge D1 and the query logical expression D2, generates the candidate hypothesis, and adds it to the candidate hypothesis set D3 (S21). Then, the candidate hypothesis extension unit 21 determines whether or not the extension of the candidate hypothesis set D3 has been completed (S25a). After that, the constraint list unit 22 lists the logical constraints to be satisfied for each candidate hypothesis in the candidate hypothesis set D3 (S22a).

Here, the constraint determination unit 23 determines whether each candidate hypothesis in the candidate hypothesis set D3 contradicts the logical constraints listed in Step S22a (S23a). When it is determined that the candidate hypothesis contradicts the logical constraint, the constraint determination unit 23 excludes the candidate hypothesis from the candidate hypothesis set D3 (S24a). If it is determined that the candidate hypothesis does not contradict the logical constraints after Step S24a or in Step S23a, the candidate hypothesis transformation unit 24 transforms the candidate hypothesis set D3 and the constraint set D4 into the corresponding constrained combinatorial optimization problem (S26) and then outputs it to the best hypothesis search unit 25. After that, the best hypothesis search unit 25 searches the candidate hypothesis set D3 for the best hypothesis D5 and then outputs it (S27).

In this way, redundant candidate hypotheses that cannot be a solution are excluded before the candidate hypothesis set D3 is transformed into the optimization problem also in this example embodiment. It is therefore possible to search for the best hypothesis with a smaller search space compared to that in Non-Patent Literature 1 or the like. Thus, memory usage efficiency and calculation efficiency can be improved.

### Other Example Embodiment

Note that the present disclosure is applicable to applications such as explanation generation and situational understanding using background knowledge and observation information. More specifically, the present disclosure is applicable to medical systems, legal consultations, or automated systems that perform risk detection, etc.

In the above example embodiment, the configuration of the hardware has been described, but it is not limited to this. This disclosure can also be achieved by having a CPU execute a computer program for arbitrary processing.

In the above example, the program can be stored using various types of non-transitory computer-readable media and supplied to a computer. The non-transitory computer-readable media include various types of tangible storage media. Examples of the non-transitory computer-readable media include magnetic recording media (for example, a flexible disk, a magnetic tape, or a hard disk drive), magneto-optical recording media (for example, magneto-optical disks), CD-ROM (Read Only Memory), a CD-R, a CD-R/W, a DVD (Digital Versatile Disc), and a semiconductor memory (for example, a mask ROM, a PROM (Programmable ROM, an EPROM (Erasable PROM), a flash ROM, or a RAM (Random Access Memory). In addition, the program may be supplied to the computer by various types of transitory computer-readable media. Examples of the transitory computer-readable medium include electric signals, optical signals, and electromagnetic waves. The transitory computer-readable medium can provide the program to the computer via a wired communication line such as electric wires and optical fibers or a wireless communication line.

The present disclosure is not limited to the above example embodiments and may be changed as appropriate without departing from the scope. In addition, the present disclosure may be implemented by combining the respective example embodiments as appropriate.

The whole or part of the example embodiments disclosed above can be described as, but not limited to, the following supplementary notes.

### (Supplementary Note A1)

An abductive reasoning apparatus comprising:
a generation unit configured to generate a candidate hypothesis from background knowledge and a query logical expression, the background knowledge being a set of given rules that if an antecedent holds, a consequent holds, and the query logical expression indicating observed information by using a logical expression;
a constraint determination unit configured to determine whether or not the generated candidate hypothesis contradicts a logical constraint to be satisfied by the generated candidate hypothesis and excluding the candidate hypothesis from a set of the generated candidate hypotheses when the candidate hypothesis contradicts the logical constraint; and
a search unit configured to search for a best hypothesis based on the set after the exclusion and then outputting the best hypothesis.

### (Supplementary Note A2)

The abductive reasoning apparatus according to Supplementary note A1, wherein
each time the generation unit generates one candidate hypothesis, the constraint determination unit determines whether or not the candidate hypothesis contradicts the logical constraint, and if the candidate hypothesis contradicts the logical constraint, excludes the candidate hypothesis from the set.

### (Supplementary Note A3)

The abductive reasoning apparatus according to Supplementary note A2, wherein
the generation unit extends the set by attempting to generate the next candidate hypothesis after the exclusion by the constraint determination unit, and
the search unit searches for the best hypothesis after convergence of the extension of the set by the generation unit and then outputs the best hypothesis.

### (Supplementary Note A4)

The abductive reasoning apparatus according to Supplementary note A2 or A3, further comprising:
a constraint list unit configured to list, each time the generation unit generates one of the candidate hypotheses, the logical constraint to be satisfied by the generated candidate hypothesis, wherein
each time the logical constraint is listed, the constraint determination unit determines whether or not the candidate hypothesis contradicts the logical constraint, and if the candidate hypothesis is inconsistent with the logical constraint, the constraint determination unit excludes the candidate hypothesis from the set.

### (Supplementary Note A5)

The abductive reasoning apparatus according to Supplementary note A4, wherein
the generation unit constructs the set of candidate hypotheses by extending a directed graph corresponding to the set of candidate hypotheses, and
the constraint list unit lists the logical constraints to be satisfied by the extension of the directed graph.

### (Supplementary Note B 1)

An abductive reasoning method comprising:
generating a candidate hypothesis from background knowledge and a query logical expression, the background knowledge being a set of given rules that if an antecedent holds, a consequent holds, and the query logical expression indicating observed information by using a logical expression;
determining whether or not the generated candidate hypothesis contradicts a logical constraint to be satisfied by the generated candidate hypothesis;
excluding the candidate hypothesis from a set of the generated candidate hypotheses when the candidate hypothesis contradicts the logical constraint; and
searching for a best hypothesis based on the set after the exclusion and then outputting the best hypothesis.

### (Supplementary Note C1)

A non-transitory computer readable medium storing an abductive reasoning program for causing a computer to execute:
processing of generating a candidate hypothesis from background knowledge and a query logical expression, the background knowledge being a set of given rules that if an antecedent holds, a consequent holds, and the query logical expression indicating observed information by using a logical expression;
processing of determining whether or not the generated candidate hypothesis contradicts a logical constraint to be satisfied by the candidate hypothesis;
excluding the candidate hypothesis from a set of the generated candidate hypotheses when the candidate hypothesis contradicts the logical constraint; and
processing of searching for a best hypothesis based on the set after the exclusion and then outputting the best hypothesis.

Although the present disclosure has been described above with reference to the above example embodiments (and examples), the present disclosure is not limited to the above example embodiments (and examples). Various modifications can be made to the configuration and details of the present disclosure within the scope of the present disclosure that would be understood by those skilled in the art.

### REFERENCE SIGNS LIST

1 ABDUCTIVE REASONING APPARATUS
11 GENERATION UNIT
12 CONSTRAINT DETERMINATION UNIT
13 SEARCH UNIT
2 ABDUCTIVE REASONING APPARATUS
21 CANDIDATE HYPOTHESIS EXTENSION UNIT
22 CONSTRAINT LIST UNIT
23 CONSTRAINT DETERMINATION UNIT
24 CANDIDATE HYPOTHESIS TRANSFORMATION UNIT
25 BEST HYPOTHESIS SEARCH UNIT
201 INPUT/OUTPUT UNIT
202 NETWORK INTERFACE
203 STORAGE APPARATUS
204 MEMORY
205 PROCESSOR
D1 BACKGROUND KNOWLEDGE
D2 QUERY LOGICAL EXPRESSION
D3 CANDIDATE HYPOTHESIS SET
D4 CONSTRAINT SET
D5 BEST HYPOTHESIS

What is claimed is:

1. An abductive reasoning apparatus comprising:
at least one memory configured to store instructions; and
at least one processor configured to execute the instructions to:
generate a candidate hypothesis from background knowledge and a query logical expression, the background knowledge being a set of given rules that if an antecedent holds, a consequent holds, and the query logical expression indicating observed information by using a logical expression;
determine whether or not the generated candidate hypothesis contradicts a logical constraint to be satisfied by the generated candidate hypothesis and exclude the candidate hypothesis from a set of the generated candidate hypotheses when the candidate hypothesis contradicts the logical constraints; and
search for a best hypothesis based on the set after the exclusion and then output the best hypothesis.

2. The abductive reasoning apparatus according to claim 1, wherein
the at least one processor is further configured to execute the instructions to:
each time generating one candidate hypothesis, determine whether or not the candidate hypothesis contradicts the logical constraint, and if the candidate hypothesis contradicts the logical constraint, exclude the candidate hypothesis from the set.

3. The abductive reasoning apparatus according to claim 2, wherein
the at least one processor is further configured to execute the instructions to:
extend the set by attempting to generate the next candidate hypothesis after the exclusion, and
search for the best hypothesis after convergence of the extension of the set and then output the best hypothesis.

4. The abductive reasoning apparatus according to claim 2, wherein
the at least one processor is further configured to execute the instructions to:
list, each time generating one of the candidate hypotheses, the logical constraint to be satisfied by the generated candidate hypothesis, and
each time the logical constraint is listed, determine whether or not the candidate hypothesis contradicts the logical constraint, and if the candidate hypothesis contradicts the logical constraint, exclude the candidate hypothesis from the set.

5. The abductive reasoning apparatus according to claim 4, wherein
the at least one processor is further configured to execute the instructions to:
construct the set of candidate hypotheses by extending a directed graph corresponding to the set of candidate hypotheses, and
list the logical constraints to be satisfied by the extension of the directed graph.

6. An abductive reasoning method performed by a computer comprising:
generating a candidate hypothesis from background knowledge and a query logical expression, the background knowledge being a set of given rules that if an antecedent holds, a consequent holds, and the query logical expression indicating observed information by using a logical expression;
determining whether or not the generated candidate hypothesis contradicts a logical constraint to be satisfied by the generated candidate hypothesis;
excluding the candidate hypothesis from a set of the generated candidate hypotheses when the candidate hypothesis contradicts the logical constraint; and
searching for a best hypothesis based on the set after the exclusion and then outputting the best hypothesis.

7. A non-transitory computer readable medium storing an abductive reasoning program for causing a computer to execute:
processing of generating a candidate hypothesis from background knowledge and a query logical expression, the background knowledge being a set of given rules that if an antecedent holds, a consequent holds, and the query logical expression indicating observed information by using a logical expression;
processing of determining whether or not the generated candidate hypothesis contradicts a logical constraint to be satisfied by the generated candidate hypothesis;
excluding the candidate hypothesis from a set of the generated candidate hypotheses when the candidate hypothesis contradicts the logical constraint; and
processing of searching for a best hypothesis based on the set after the exclusion and then outputting the best hypothesis.
